(19) United States
(12) Patent Application Publication
(10) Pub. No.: US 2024/0070979 A1
(43) Pub. Date: Feb. 29, 2024

(54) METHOD AND APPARATUS FOR GENERATING 3D SPATIAL INFORMATION

(71) Applicant: ELECTRONICS AND TELECOMMUNICATIONS RESEARCH INSTITUTE, Daejeon (KR)

(72) Inventor: Yun-Ji BAN, Gwangju (KR)

(73) Assignee: ELECTRONICS AND TELECOMMUNICATIONS RESEARCH INSTITUTE, Daejeon (KR)

(21) Appl. No.: 18/339,489

(22) Filed: Jun. 22, 2023

(30) Foreign Application Priority Data
Aug. 29, 2022 (KR) 10-2022-0108142

(51) Int. Cl. G06T 17/00; G06T 7/13; G06T 7/73; G06T 15/04

(52) U.S. Cl. CPC G06T 17/00; G06T 7/13; G06T 7/73; G06T 15/04; G06T 2207/10016; G06T 2207/20081; G06T 2207/20084; G06T 2207/30244; G06T 2210/56

(57) ABSTRACT

Disclosed herein is a method for generating 3D spatial information. The method may include detecting feature points in an image sequence, creating a sparse point cloud by predicting camera information based on the feature points, creating a mesh based on the sparse point cloud, detecting the line of an object in the image sequence using a deep-learning model, modifying the mesh based on the line, and performing texture mapping on the modified mesh.

### CROSS REFERENCE TO RELATED APPLICATION

This application claims the benefit of Korean Patent Application No. 10-2022-0108142, filed Aug. 29, 2022, which is hereby incorporated by reference in its entirety into this application.

### BACKGROUND OF THE INVENTION

### 1. Technical Field

The present disclosure relates to a 3D spatial information generation method and apparatus for generating 3D spatial information using a deep-learning technique.

### 2. Description of the Related Art

Recently, the necessity of generation of 3D spatial information has been increased with development of 3D reconstruction technology based on images and popularization of a metaverse environment.

3D spatial information generation technology is technology for generating a 3D space by searching for feature points in an image sequence, calculating the accurate positions of cameras, creating a depth image and dense points based on the camera information, creating a mesh, and performing texture mapping.

This conventional method enables generation of a high-quality 3D space, but has problems in which it takes a long time to create dense points depending on the number of input images and in which the step of creating a mesh from the dense points and performing texture mapping is also time-consuming.

Deep-learning technology shows good performance, particularly when searching for or classifying objects based on images, so it is used in various fields. Because it takes a long time to create dense points, dense points are not created, and a mesh may be created using tie points that are created to locate the positions of cameras.

However, because a mesh created from tie points has a small number of points, a high-quality mesh may not be created. Particularly, there is a problem in which, when an angled building is reconstructed, the edge thereof looks crumbled.

### SUMMARY OF THE INVENTION

An object of the present disclosure is to provide a 3D spatial information generation method and apparatus for more accurately representing a 3D space by complementing an edge area of a mesh using deep-learning technology.

In order to accomplish the above object, a method for generating 3D spatial information according to an embodiment may include detecting feature points in an image sequence, creating a sparse point cloud by predicting camera information based on the feature points, creating a mesh based on the sparse point cloud, detecting a line of an object in the image sequence using a deep-learning model, modifying the mesh based on the line, and performing texture mapping on the modified mesh.

The mesh may be modified by placing an object edge area of the mesh on the line. The object edge area of the mesh may be modified using the line.

The mesh may be modified by placing positions of points of an object edge area of the mesh on the line.

The deep-learning model may include a Lookup-based Convolutional Neural Network (LCNN).

The camera information may include at least one of a camera position, or a camera parameter, or a combination thereof.

The feature points may be detected by applying a Scale Invariant Feature Transform (SIFT) algorithm to the image sequence.

The camera information may be predicted from the feature points using a Structure-from-Motion (SfM) algorithm.

The mesh may be created from the sparse point cloud using a Poisson surface reconstruction algorithm.

The image sequence may include multi-view images.

Also, in order to accomplish the above object, an apparatus for generating 3D spatial information according to an embodiment includes memory in which a control program for generating 3D spatial information is stored and a processor for executing the control program stored in the memory. The processor may detect feature points in an image sequence, create a sparse point cloud by predicting camera information based on the feature points, create a mesh based on the sparse point cloud, detect a line of an object in the image sequence using a deep-learning model, modify the mesh based on the line, and perform texture mapping on the modified mesh.

The processor may modify the mesh by placing an object edge area of the mesh on the line.

The processor may modify the object edge area of the mesh using the line.

The processor may modify the mesh by placing positions of points of an object edge area of the mesh on the line.

The deep-learning model may include a Lookup-based Convolutional Neural Network (LCNN).

The camera information may include at least one of a camera position, or a camera parameter, or a combination thereof.

The processor may detect the feature points by applying a Scale Invariant Feature Transform (SIFT) algorithm to the image sequence.

The processor may predict the camera information from the feature points using a Structure-from-Motion (SfM) algorithm.

The processor may create the mesh from the sparse point cloud using a Poisson surface reconstruction algorithm.

The image sequence may include multi-view images.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for generating 3D spatial information according to an embodiment;

FIG. 2 is a flowchart illustrating a process of modifying a mesh using a line in a method for generating 3D spatial information according to an embodiment;

FIG. 3 is a view illustrating a sparse point cloud according to an embodiment;

FIG. 4 is a view illustrating a mesh created from a sparse point cloud according to an embodiment;

FIG. 5 is a view illustrating an enlarged part of a mesh according to an embodiment;

FIG. 6 is a view illustrating lines extracted from an image sequence according to an embodiment;

FIG. 7 is a view illustrating a mesh to which lines are applied according to an embodiment; and

FIG. 8 is a block diagram illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

In the present specification, each of expressions such as “A or B”, “at least one of A and B”, “at least one of A or B”, “at least one of A, B, and C”, and “at least one of A, B, or C” may include any one of the items listed in the expression or all possible combinations thereof.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

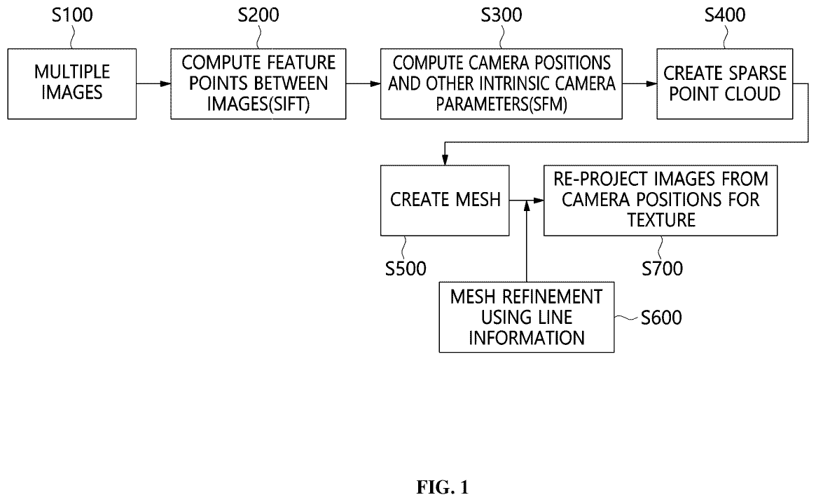

FIG. 1 is a flowchart illustrating a method for generating 3D spatial information according to an embodiment.

Referring to FIG. 1, the method for generating 3D spatial information according to an embodiment may include collecting an image sequence at step S100, detecting feature points in the image sequence at step S200, predicting camera information based on the feature points at step S300, creating a sparse point cloud in the process of predicting the camera information at step S400, creating a mesh based on the sparse point cloud at step S500, detecting a line of an object in the image sequence using a deep-learning model and modifying the mesh based on the line at step S600, and performing texture mapping on the modified mesh at step S700. Here, the method for generating 3D spatial information may be performed in a 3D spatial information generation apparatus.

The 3D spatial information generation apparatus may receive an image sequence at step S100. The image sequence may include a plurality of multi-view images.

The 3D spatial information generation apparatus may detect feature points in the image sequence at step S200. The 3D spatial information generation apparatus may detect the feature points using a Scale Invariant Feature Transform (SIFT) algorithm.

The 3D spatial information generation apparatus may predict camera information based on the feature points at step S300. The camera information may include at least one of a camera position, or camera parameters, or a combination thereof. The 3D spatial information generation apparatus may predict the camera information from the feature points using a Structure-from-Motion (SfM) algorithm.

The 3D spatial information generation apparatus may acquire a sparse point cloud that is created in the process of predicting the camera information at step S400.

The 3D spatial information generation apparatus may create a mesh from the sparse point cloud at step S500. The 3D spatial information generation apparatus may create a mesh using a Poisson surface reconstruction algorithm.

In the conventional method, a process of creating a depth image from a sparse point cloud based on camera information and creating a dense point cloud is performed, but an embodiment skips the process of creating a depth image and creating a dense point cloud, thereby having an effect of reducing processing time for 3D spatial information generation.

Meanwhile, when a mesh is created from a sparse point cloud in an embodiment, the quality may be degraded compared to a mesh that is created from a dense point cloud according to the conventional method. Therefore, in the embodiment, line information is extracted from the image sequence, and the line information is applied to the mesh, whereby the quality of the mesh may be improved.

The 3D spatial information generation apparatus according to an embodiment may detect a line in the image sequence and apply the detected line to the mesh at step S600.

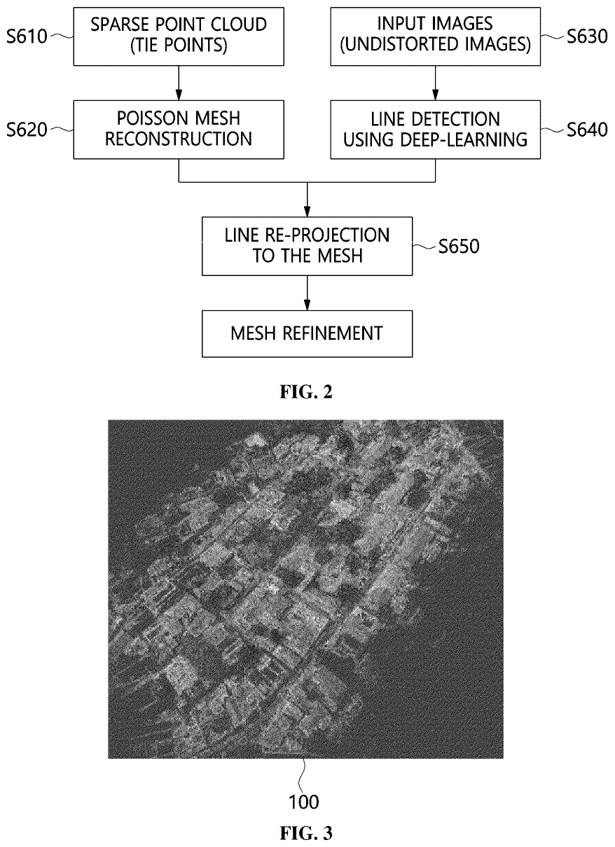

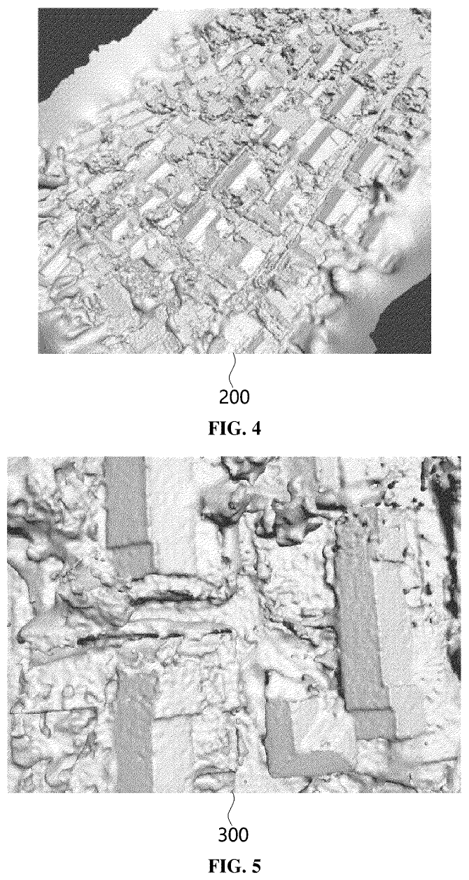

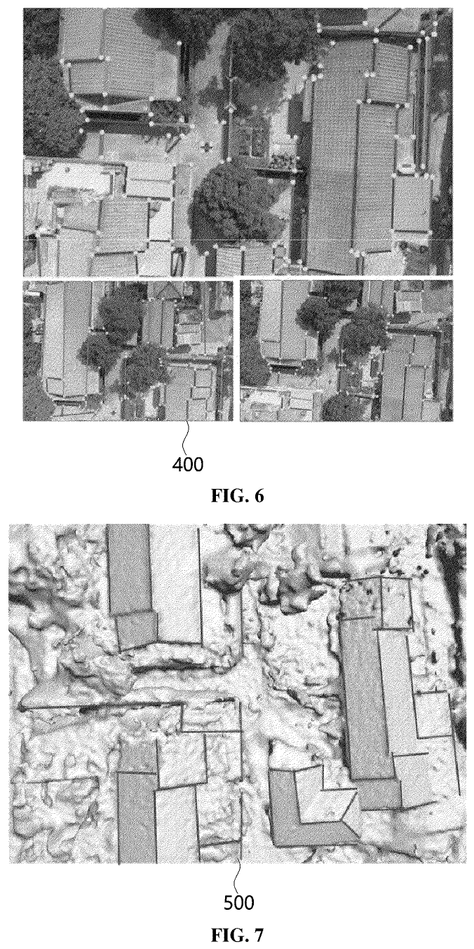

FIG. 2 is a flowchart illustrating a process of modifying a mesh using a line in the method for generating 3D spatial information according to an embodiment, FIG. 3 is a view illustrating a sparse point cloud according to an embodiment, FIG. 4 is a view illustrating a mesh created from a sparse point cloud according to an embodiment, FIG. 5 is a view illustrating an enlarged part of a mesh according to an embodiment, FIG. 6 is a view illustrating a line extracted from an image sequence according to an embodiment, and FIG. 7 is a view illustrating a mesh to which a line is applied according to an embodiment.

Referring to FIG. 2, the 3D spatial information generation apparatus may acquire a sparse point cloud at step S610. The sparse point cloud 100 is as shown in FIG. 3.

The 3D spatial information generation apparatus may create a mesh 200 by applying a Poisson surface reconstruction algorithm to the sparse point cloud at step S620. The mesh is as shown in FIG. 4, and an enlarged part 300 of the mesh 200 is as shown in FIG. 5.

As illustrated in FIG. 5, it can be seen that the straight lines of the mesh 300 are not correctly represented when the mesh 300 is created from the sparse point cloud 100.

Referring back to FIG. 2, the 3D spatial information generation apparatus may acquire an image sequence, which includes multi-view images, at step S630. The 3D spatial information generation apparatus may extract line information by inputting the image sequence to a deep-learning model.

The image sequence may be undistorted images. The line information may be line information about objects in the image sequence. For example, the objects may include buildings, trees, stones, and the like, and the line information may include lines of the edge areas of buildings, trees, stones, and the like. The deep-learning model may be, for example, a Lookup-based Convolutional Neural Network (LCNN), but is not limited thereto.

As illustrated in FIG. 6, the lines 400 of a roof or a wall may be detected in the image sequence as the result of using the LCNN.

Referring back to FIG. 2, the 3D spatial information generation apparatus may remap the lines to the mesh at step S650. The 3D spatial information generation apparatus may place the object edge area of the mesh on the line. The 3D spatial information generation apparatus may modify the object edge area of the mesh using the line.

More specifically, the 3D spatial information generation apparatus may place the positions of points of the object edge area of the mesh on the line. The 3D spatial information generation apparatus may modify the points of the object edge area of the mesh using the line.

Through the above-described process, the 3D spatial information generation apparatus may acquire the modified mesh.

As illustrated in FIG. 7, when the mesh is modified using the line, the edge area of the modified mesh 500 may be refined to be in the form of straight lines, whereby the 3D spatial information may be more effectively represented.

Referring back to FIG. 1, the 3D spatial information generation apparatus performs texture mapping on the mesh, thereby completing the process of generating a final 3D space at step S700.

The apparatus for generating 3D spatial information according to an embodiment may be implemented in a computer system including a computer-readable recording medium.

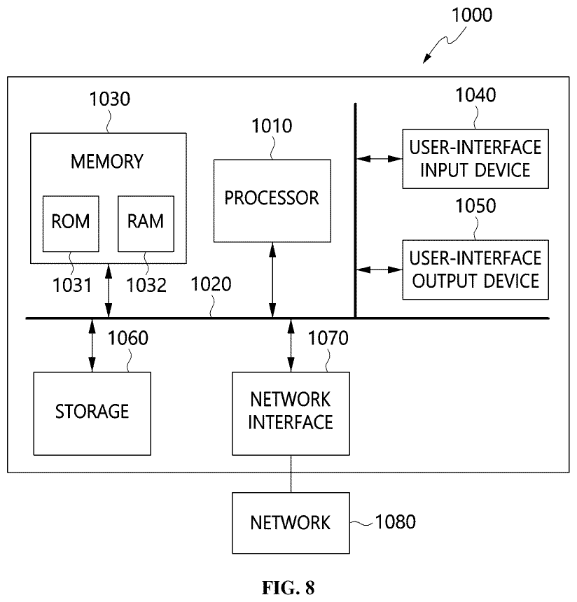

FIG. 8 is a block diagram illustrating the configuration of a computer system according to an embodiment.

Referring to FIG. 8, the computer system 1000 according to an embodiment may include one or more processors 1010, memory 1030, a user-interface input device 1040, a user-interface output device 1050, and storage 1060, which communicate with each other via a bus 1020. Also, the computer system 1000 may further include a network interface 1070 connected to a network.

The processor 1010 may be a central processing unit or a semiconductor device for executing a program or processing instructions stored in the memory or the storage. The processor 1010 is a kind of central processing unit, and may control the overall operation of the apparatus for generating 3D spatial information.

The processor 1010 may include all kinds of devices capable of processing data. Here, the ‘processor’ may be, for example, a data-processing device embedded in hardware, which has a physically structured circuit in order to perform functions represented as code or instructions included in a program. Examples of the data-processing device embedded in hardware may include processing devices such as a microprocessor, a central processing unit (CPU), a processor core, a multiprocessor, an application-specific integrated circuit (ASIC), a field-programmable gate array (FPGA), and the like, but are not limited thereto.

The memory 1030 may store various kinds of data for overall operation, such as a control program, and the like, for performing a method for generating 3D spatial information according to an embodiment. Specifically, the memory may store multiple applications running in the apparatus for generating 3D spatial information and data and instructions for operation of the apparatus for generating 3D spatial information.

The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to an embodiment, the computer-readable recording medium storing a computer program therein may contain instructions for making a processor perform a method including an operation for detecting feature points in an image sequence, an operation for creating a sparse point cloud by predicting camera information based on the feature points, an operation for creating a mesh based on the sparse point cloud, an operation for detecting a line of an object in the image sequence using a deep-learning model, an operation for modifying the mesh based on the line, and an operation for performing texture mapping on the modified mesh.

According to an embodiment, a computer program stored in the computer-readable recording medium may include instructions for making a processor perform an operation for detecting feature points in an image sequence, an operation for creating a sparse point cloud by predicting camera information based on the feature points, an operation for creating a mesh based on the sparse point cloud, an operation for detecting a line of an object in the image sequence using a deep-learning model, an operation for modifying the mesh based on the line, and an operation for performing texture mapping on the modified mesh.

An embodiment has an effect of reducing processing time by skipping a process of creating a depth image and a dense point cloud.

Also, an embedment has an effect of generating high-quality 3D spatial information by modifying an edge line of a mesh using line information.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for generating 3D spatial information, comprising:
detecting feature points in an image sequence;
creating a sparse point cloud by predicting camera information based on the feature points;
creating a mesh based on the sparse point cloud;
detecting a line of an object in the image sequence using a deep-learning model;
modifying the mesh based on the line; and
performing texture mapping on the modified mesh.

2. The method of claim 1, wherein the mesh is modified by placing an object edge area of the mesh on the line.

3. The method of claim 2, wherein the object edge area of the mesh is modified using the line.

4. The method of claim 1, wherein the mesh is modified by placing positions of points of an object edge area of the mesh on the line.

5. The method of claim 1, wherein the deep-learning model includes a Lookup-based Convolutional Neural Network (LCNN).

6. The method of claim 1, wherein the camera information includes at least one of a camera position, or a camera parameter, or a combination thereof.

7. The method of claim 1, wherein the feature points are detected by applying a Scale Invariant Feature Transform (SIFT) algorithm to the image sequence.

8. The method of claim 1, wherein the camera information is predicted from the feature points using a Structure-from-Motion (SfM) algorithm.

9. The method of claim 1, wherein the mesh is created from the sparse point cloud using a Poisson surface reconstruction algorithm.

10. The method of claim 1, wherein the image sequence includes multi-view images.

11. An apparatus for generating 3D spatial information, comprising:
memory in which a control program for generating 3D spatial information is stored; and
a processor for executing the control program stored in the memory,
wherein the processor detects feature points in an image sequence, creates a sparse point cloud by predicting camera information based on the feature points, creates a mesh based on the sparse point cloud, detects a line of an object in the image sequence using a deep-learning model, modifies the mesh based on the line, and performs texture mapping on the modified mesh.

12. The apparatus of claim 11, wherein the processor modifies the mesh by placing an object edge area of the mesh on the line.

13. The apparatus of claim 12, wherein the processor modifies the object edge area of the mesh using the line.

14. The apparatus of claim 11, wherein the processor modifies the mesh by placing positions of points of an object edge area of the mesh on the line.

15. The apparatus of claim 11, wherein the deep-learning model includes a Lookup-based Convolutional Neural Network (LCNN).

16. The apparatus of claim 11, wherein the camera information includes at least one of a camera position, or a camera parameter, or a combination thereof.

17. The apparatus of claim 11, wherein the processor detects the feature points by applying a Scale Invariant Feature Transform (SIFT) algorithm to the image sequence.

18. The apparatus of claim 11, wherein the processor predicts the camera information from the feature points using a Structure-from-Motion (SfM) algorithm.

19. The apparatus of claim 11, wherein the processor creates the mesh from the sparse point cloud using a Poisson surface reconstruction algorithm.

20. The apparatus of claim 11, wherein the image sequence includes multi-view images.
